(19) United States
(12) Patent Application Publication
(10) Pub. No.: US 2012/0221686 A1
(43) Pub. Date: Aug. 30, 2012

(54) DATA COLLECTION METHOD AND APPARATUS

(75) Inventor: Oliver Chadwick, Farnham (GB)

(73) Assignee: Vision Critical Limited

(21) Appl. No.: 12/997,706

(22) PCT Filed: Jun. 11, 2009
(86) PCT No.: PCT/GB09/50663

§ 371 Date: Feb. 6, 2012

(30) Foreign Application Priority Data
Jun. 13, 2008 (GB) 0801884.7

(51) Int. Cl. G06F 15/16; G06F 21/00; G06F 17/30

(52) U.S. Cl. 709/219; 707/792; 713/183; 707/E17.005

(57) ABSTRACT

A data extraction module for extracting data stored in a database management system of a computer system in Internet, the database management system comprising a database and a management application for accessing the database, the data extraction module comprising: inputs for receiving a request for data stored in the database; extraction means for accessing and extracting the requested data from the database; outputs for outputting the extracted data wherein the extraction means is arranged to bypass the management application and access the database independently of the management application.

### FIELD OF INVENTION

The present invention relates to a data collection method and apparatus. In particular, the present invention relates to a method (and corresponding apparatus) of extracting/mining data from a database associated with a computer application.

### BACKGROUND OF THE INVENTION

A database management system is a computer program/application/package that is used to manage and query a structured collection of records or data, i.e. a database. Many database management systems (DBMS) allow a user to query the database regarding the data contained therein and the results of such queries may be presented in the form of a report generated by the DBMS. In the following description, the terms DBMS and database management package are used inter-changeably.

Data may be extracted from databases in a number of different ways, each of which is associated with one or more disadvantages.

The simplest method of gaining access to data in a DBMS is, as noted above, to rely on the standard reports provided by the particular management system and to export the data in a suitable format, such as Excel® format or “.txt” format. Once produced the file can be presented to an end user.

In the context of a financial DBMS, e.g. Sage Line 50 Accountant, the database management package is used to store various customer details relating to a business and a report may be created for internal use by the business in question. Alternatively, a report may be generated for transmission to a bank, status information company or other business and hereinafter such recipients of a report are referred to as “End Users”. It is also noted that in the following description, the business running the DBMS is referred to as either the client or Target.

A problem with this approach is where the End User requires data from a number of different database management systems, each of which present their data in a different manner within their standard reporting formats. Another problem with this approach is where the End User requires data from a DBMS that is not contained within the standard report format, i.e. the DBMS may comprise data which is not selectable as a report output.

Another method of extracting data from a database is to use an application programming interface (API) in which the vendor of the DBMS or a third party write code, specific to the database management package in question, that creates reports to the requirements of the End User. Where the API solution is used, typically an icon on the menu bar of the database management package will create a file to the specification of the End User. The file can be stored on a local hard drive for later posting via email or a web site to the End User.

The major problem with this method is when the End User requires data from a number of different clients (/Targets) who have a variety of different database management packages. In such a situation it would be necessary to produce APIs for each package used by the various Targets.

The API extraction method also has drawbacks associated with the maintenance of the service, e.g. as Targets change computers, upgrade their database management packages or upgrade their computer network firewalls. Any such changes would require the End User to coordinate with the Target and vendor of the database management package in order to ensure the API is current and up-to-date.

The API strategy is also viewed as relatively high risk as database management systems can be fragile and prone to failure and the introduction of an API could cause unknown damage or destabilise the package.

An API also requires that the End User has detailed access to the Target's computer systems which could present a security issue.

A further method of data extraction is the use of a schema produced by the End User which details to the Target the required report specification for the requested data. Once the schema has been received, the Target generates a file which is then saved to a local storage area of their computer system.

There are a number of drawbacks with this solution. The End User has, for example, to rely on the Target having the resources to create the file. The file must also be created each time the Target is required to send it to the End User. This is a time consuming process as the process is not automatic.

Further drawbacks with this approach are that: (i) the file stored on the Target's computer system consumes resources; (ii) the file is not secure as it can be amended by the Target once created; (iii) errors or problems in the file need to be diagnosed by the End User and a solution subsequently proposed to the Target, a procedure which is costly and which consumes resources; (iv) if the Target needs to generate reports relating to multiple types of data (e.g. reports relating to multiple companies or products that it has business dealings with) then it is required to provide individual files to the End User and it is required to provide these for each instance of the data.

A variation to the schema-based method above is an electronic data interchange (EDI) based method of data extraction in which the Target and End User are connected via a hardened electronic connection. Although this method improves the security of the data file whilst in transit it does not address the problems, associated with other schema-based systems, that the information may be inaccurate or may be tampered with during the creation of the data file.

In addition, an EDI based method requires expensive equipment to be installed at either end of the communications link and often requires expert assistance to install and maintain the necessary hardware and software.

It is therefore an object of the present invention to provide a data extraction apparatus and corresponding method that overcomes or substantially mitigates the above mentioned problems.

### STATEMENTS OF INVENTION

According to a first aspect of the present invention there is provided a data extraction module for extracting data stored in a database management system of a computer system, the database management system comprising a database and a management application for accessing the database, the data extraction module comprising: inputs for receiving a request for data stored in the database; extraction means for accessing and extracting the requested data from the database; outputs for outputting the extracted data wherein the extraction means is arranged to bypass the management application and access the database independently of the management application.

The present invention provides a mechanism for extracting data from a database that does not suffer from the problems associated with the prior art. A data extraction module is provided which is capable of directly accessing the data records within the database. The module is provided with knowledge of the database management system in use and is then capable of extracting data without relying on the management application. In effect the management application is bypassed and the database is accessed directly by the data extraction module.

It is noted that the request for data stored in the database may originate from a specific request from a user or may originate as part of a scheduled task on the computer system.

Conveniently, where the management application comprises a database driver for accessing the database, the extraction means may be arranged to use the driver to extract data from the database. In the event that the management application has no database driver then the data extraction module may be provided with a suitable driver.

In the event that the database comprises a plurality of data records the data extraction means may be arranged to insert a dummy data record comprising a unique reference number into the database. Such a dummy record may usefully be able to distinguish between different (unrelated) sections of the database (e.g. between different ledgers that are stored in the same database) and may also be used to identify the owner of the database to an end user.

Conveniently where the database management system is password protected the data extraction module is arranged to encrypt and store the password details on the computer system. By storing the encrypted password details on a local storage area of the computer system an end user, remote from the computer system, is not required to hold a copy of the database management log in details (he is only required to hold the log in details of the data extraction module).

The extracted data may conveniently be output in the form of a data file which may be encrypted and which may be sent to a local storage area for later transmission to an end user. Alternatively, the data file may be output to a mail application for emailing to a remote computer server. As a further alternative the data extraction module may comprise FTP means which is arranged to transmit the data file. The data extraction module may also further comprise checking means which is arranged to check the veracity of the extracted data prior to transmission.

The data extraction module may conveniently be embodied in the form of a computer application and may comprise a profile component and an executable component, the profile component being arranged to insert a dummy record into the database and the executable component being arranged to access and extract requested data from the database.

According to a second aspect the present invention provides a method of extracting data stored in a database management system of a computer system, the database management system comprising a database and a management application for accessing the database, the method comprising: receiving a request for data stored in the database; accessing and extracting by means of a data extraction module the requested data from the database; outputting the extracted data wherein the data extraction module bypasses the management application and accesses the database independently of the management application.

According to a third aspect the present invention provides a method of setting up a data extraction module in a computer system, the data extraction module being arranged to extract data stored in a database management system of the computer system, the database management system comprising a database and a management application for accessing the database, the method comprising the steps of: installing a profile component on the computer system, the profile component being arranged to insert a data record into the database, the data record comprising a unique reference number; installing an executable component on the computer system, the executable component being arranged to provide the computer system with extraction means arranged to access and extract data from the database independently of the management application.

The present invention also extends to a computer program comprising program instructions for causing a computer to perform the methods of the second and third aspects of the present invention. The computer program may be embodied on a record medium/read-only memory/electrical carrier signal or stored in a computer memory.

### BRIEF DESCRIPTION OF THE DRAWINGS

In order that the invention may be more readily understood, reference will now be made, by way of example, to the accompanying drawings in which:

FIG. 1 shows the system architecture of a known, prior art, database management system and report generation system;

FIG. 2 shows a computer system and database management system that comprises a data extraction module in accordance with an embodiment of the present invention;

FIG. 3 shows a flow chart of a data extraction process in accordance with an embodiment of the present invention;

FIG. 4 shows a plurality of computer systems (as depicted in FIG. 2) connected via a communications network to an End User;

FIG. 5 shows a flow chart of the operation of a data processing server which is arranged to receive extracted data;

FIG. 6 is a flow chart of a download and set up process for installing a data extraction module in accordance with an embodiment of the present invention on a computer system having a database management system and associated database;

FIGS. 7 to 10 are screenshots of an embodiment of the present invention which show the creation of a dummy account (a “Trace Debtor”) within the database management system;

FIG. 11 shows a screenshot of an End User's website after a report has been received from the data extraction module of FIG. 2;

FIG. 12 shows example of schema used to store data extracted from a database management system.

It is noted that in the following description the terms “management application” and “application package” are considered interchangeable. It is further noted that like numerals have been used in the Figures to denote like features.

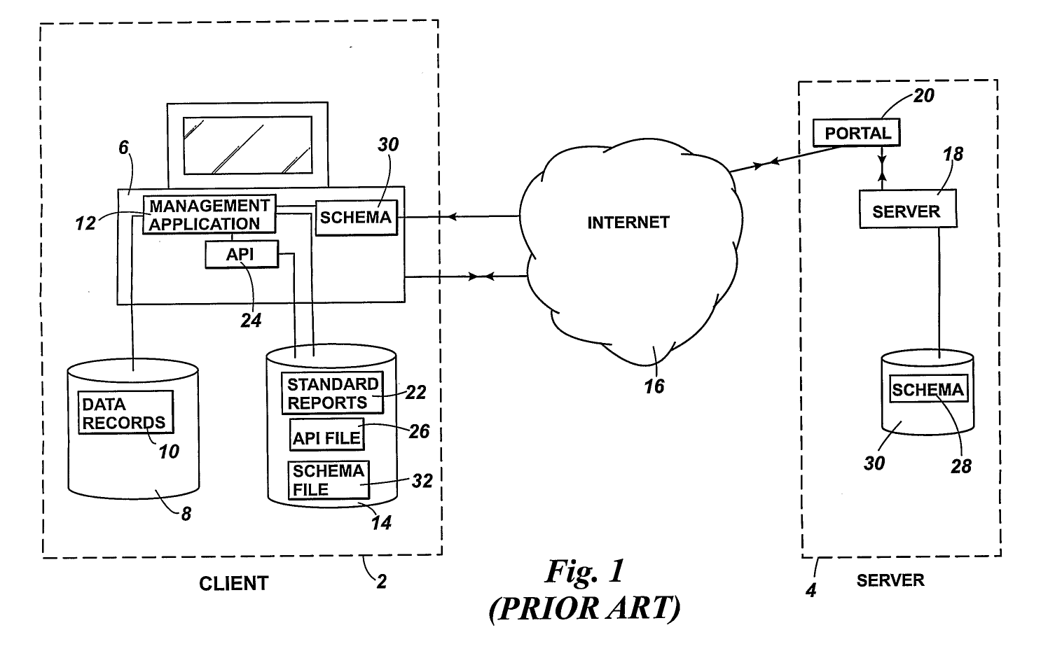

FIG. 1 shows various arrangements that may be used to extract data from a database management system.

Referring to FIG. 1, there is shown a client-server computer system comprising a client, or Target, side 2 and a server side 4.

The client/Target side 2 of the computer system comprises a remote client computer 6 which is provided with an Internet or web browser for displaying web pages (not shown). The remote client computer 6 also comprises a database 8, within which a plurality of data records 10 are stored, and is arranged to run an application 12 for managing incoming data, and for filing and retrieving data records from the database 8.

The remote client computer 6 may also comprise a data store 14 as described below. Although only a single remote client computer is shown in FIG. 1 on the client side of the computer system it is to be appreciated that there may be a plurality of remote client computers each of which are connected via the Internet 16 (or other suitable communications network) to the server side of the computer system.

The server side 4 of the computer system comprises a server computer 18 with web server capability. The server computer is associated with an End User wishing to extract data records from the client side of the computer system.

The remote client computer 6 and server computer 4 may communicate via a web portal 20 and the Internet 16 (or other suitable communications network).

A user on the server side 4 of the computer system may obtain a report on the data records 10 held in the database 8 in a number of ways.

In a first method of extracting data records 10 from the database 8, a request may be made to a user of the remote client computer 6 or of the database management application 12 for a standard report 22, i.e. an End User may ask, via the server computer 18 and web portal 20, the management application to produce its own standard report.

Once produced, the report 22 generated by the management application 12 can be stored in the data store 14 for later transmission via the Internet 16 to the server computer 18. Alternatively, it may be sent immediately upon generation.

As noted above, such a method limits the End User to only being able to access and request data in a format determined by the application package running on the remote client computer.

In a second method of extracting data records 10 from the database 8, an application programming interface (API) 24 may be installed on the remote client computer. As shown in FIG. 1, the API 24 interacts with the application and is capable of generating its own report (API file 26 in FIG. 1) which may be stored (in the data store 14) for transmission to the server computer 18.

The API 24 comprises code that is specific to the application on the remote client computer.

The drawback of this method is that the API code needs to be tailored to the particular application running on the remote client computer. Updates to that application may reduce or negate the effectiveness of the API code and the code itself may destabilise the application package to the extent that it cannot function.

A further method of extracting data records from the database involves the use of a schema 28 that is supplied from a user on the server side 4 of the computer system. FIG. 1 therefore also depicts a data store 30 in communication with the server computer 18. The data store comprises a schema 28 or template which details the information required from the Target's data records.

The schema is provided to the remote client computer and is stored on the hard drive of the client's computer (see schema module 30 in FIG. 1). When the Target is asked to send a report to the End User they prepare a schema file 32 containing the requested information which may then be stored in the second data store for later transmission to the End User. It is noted that the transmission of the API file would generally comprise the Target user logging onto a secure portal, browsing their hard drive to find the API file and then sending the file over the internet to the End User's computer system.

It is noted that the report transmission process may initially be a manual process which is then automated once the system has been set up correctly. In normal use, the schema is provided to allow the Target to write a report using their own management application report writer tool/wizard. This report can then be stored and re-run each time a report needs to be sent to the End User.

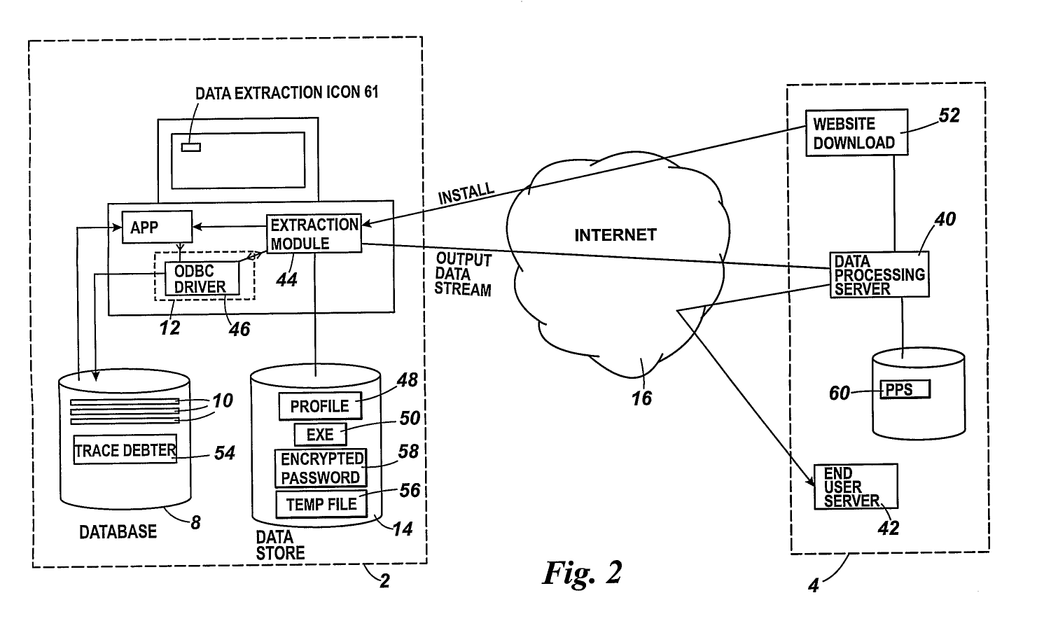

FIG. 2 shows a computer system comprising a data extraction module in accordance with an embodiment of the present invention.

As in FIG. 1, the computer system comprises a client side 2 comprising a remote client computer and a server side 4 comprising a data processing server 40 and an End User server 42.

In the system shown in FIG. 2 a data extraction module 44 running on the remote client computer 6 enables the extraction of data records from the database 8 associated with a management application.

In FIG. 2, the remote client computer is further provided with a database driver 46 (a software routine) which is provided with details of the database 8 and which enables the management application 12 to store and retrieve data from the database. It is noted that the database driver 46 will normally either be native to the database management application or available as an “add-on” application. In the event that the driver is not either native or available separately it may be supplied as part of the data extraction module 44 of the present invention.

The extraction module 44 comprises two component files, a profile file 48 and an executable file 50. It is expected that these files would be downloaded from a suitable website 52, e.g. the website depicted in FIG. 2. However, the component files may be provided as files on a CD, DVD or other suitable storage device. As shown in FIG. 2, the two component files are stored in the data store 14 within the remote client computer 6.

The database 8 associated with the remote client computer comprises a plurality of data records 10 (e.g. in the example of an accounts package these data records may be debtor records) and additionally a dummy data record 54. This dummy data record, or Trace debtor (in the context of a financial DBMS), is described in greater detail below but is inserted into the database by the data extraction module in order to allow extracted data records to be identified.

The present embodiment of the invention recognises that data may be directly extracted from the database without using the management application. In other words, the data extraction module bypasses the management application and accesses the database directly. Furthermore, the data extraction module may use the database drivers 46 associated with the management application to extract the data records from the database 8. Following extraction this data may be stored as a temporary file 56 in the data store 14 before being output in an output data stream to a data processing server which then forwards the data stream to a server of the End User.

In certain circumstances a client's database may be configured to hold two or more unrelated ledgers, e.g. a client who sells spare parts and also provides consultancy services may have a database that comprises a spare parts sales ledger and also a consultancy ledger. In order that the data extracted by the data extraction module relates to the relevant ledger, the profile file 48 of the downloaded component files is arranged to insert a dummy data record into the database. This dummy record comprises a unique reference number in one of the data fields of the data record but is otherwise blank. When a report is generated by the data extraction module for the End User the module can easily identify the relevant data records by looking up the reference number within the dummy data record.

It is noted that the dummy data record may also be used by the data processing server 40 to identify which End User it should forward a report onto. As shown in FIG. 2, the dummy record is stored in the database along with the data records.

It is noted that the use of a dummy data record provides a convenient mechanism for identifying a client to the data processing server or End User when it receives data records from the client. By embedding the unique reference number in a specially created data record the present invention avoids the need to attach any specially created “message header”-type identifiers to communications output from the client. In the example of an accounting management package, the dummy record may be viewed as a dummy debtor (a Trace debtor) in their accounting package.

The executable file comprises a computer application that sets up the data extraction module on the remote client computer and which enables data to be extracted from the database using the database drivers associated with the management application.

During the installation of the data extraction module on a remote client computer, a data extraction icon 61 may be inserted onto the desktop screen of the remote client computer so that a client user can run the data extraction module when required.

In the example shown in FIG. 2 the End User's server does not directly receive the data output from the data extraction module. Instead, the output data is sent to a data processing server which is provided with a pre-processing and processing application module 60 which receives the data output from the data extraction module and configures it for the operational infrastructure of the End User. It is, however, noted that the client may send the output data directly to the End User.

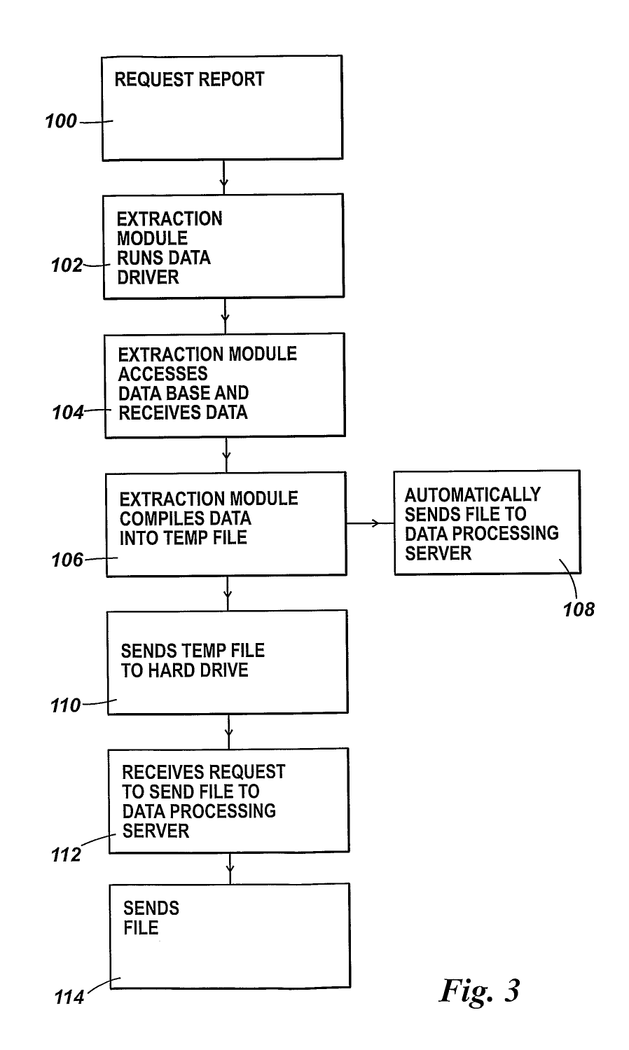

FIG. 3 shows a flow chart of the data extraction process in accordance with an embodiment of the present invention.

In Step 100, the data extraction module 44 receives a request to generate a report for the End User. This request may come from the End User via, for example, an email, or alternatively it may arise as a result of the client running the data extraction module, e.g. by double-clicking on a desktop icon. As a further alternative, the data extraction module may, upon installation, set up a NT scheduled task which runs the data extraction application at an agreed frequency and time.

In Step 102, the data extraction module 44 accesses and runs the database driver associated with the database and management application.

In Step 104, the data extraction module 44 accesses the database and collects the data required for the requested report. This data is then compiled, in Step 106, into a temporary file 56.

At this point, depending upon the set up of the data extraction module, the temporary file can either be automatically sent, as in Step 108, to the data processing server (or direct to the End User) via the Internet (or another suitable communications network). Alternatively, it may be stored locally, as in Step 110, on the remote client computer, e.g. on the hard drive of the computer.

In the event that the file is locally stored, the data extraction module may, at Step 112, receive a further request to send the temporary file to the data processing server. In Step 114, the module then sends the file to the server via a suitable communications network.

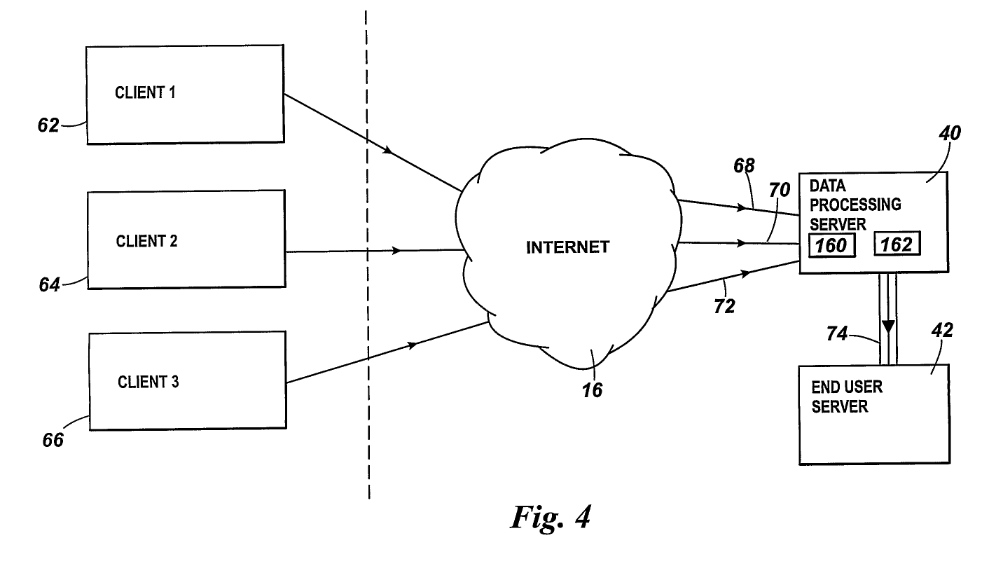

FIG. 4 shows a further embodiment of the present invention in which the End User receives data reports from multiple clients. As shown in the Figure there are three clients (62, 64, 66) on the client side of the computer system and it is noted that each client will have a remote client computer set up as per the computer depicted in FIG. 2.

Each client computer will extract and export data in the manner previously described and the data processing server will receive three separate data streams (68, 70, 72), one from each client.

The pre-processing software 60 running on the data processing server 40 will then look for an Agreement number (as described later) in each data stream in order to identify the client from which it originated.

In the further embodiment of FIG. 4, processing software 160, 162 running on the data processing server then collates all the data records for a particular End User and outputs a unified data stream 74 to the End User's server 42.

In more detail, it is noted that the data processing server is arranged to take the plurality of un-unified data records and to convert them, using conversion software module 160, into a common and therefore unified form. This unified form is then stored as “raw” unified data on the data processing server data base in an SQL Database. It is noted that the “raw” unified data is not saved with respect to any particular file extension such as .tsv .csv .xml.

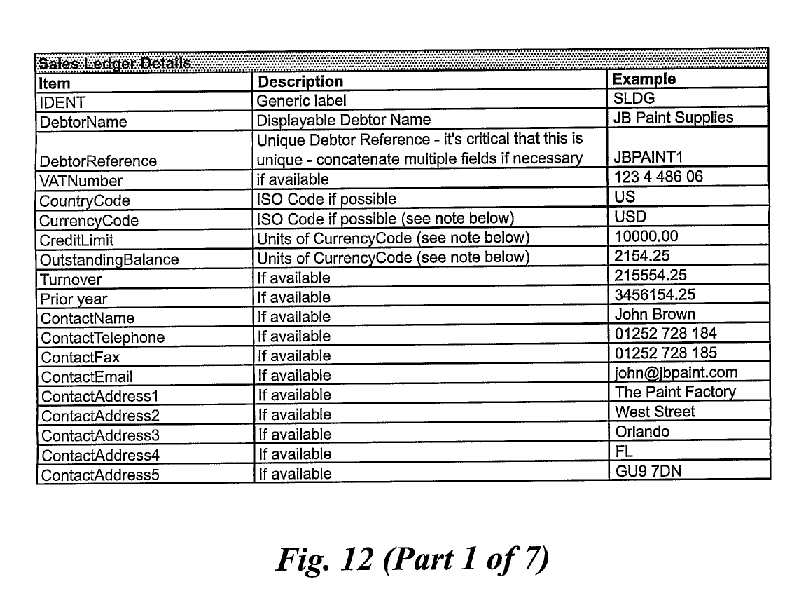

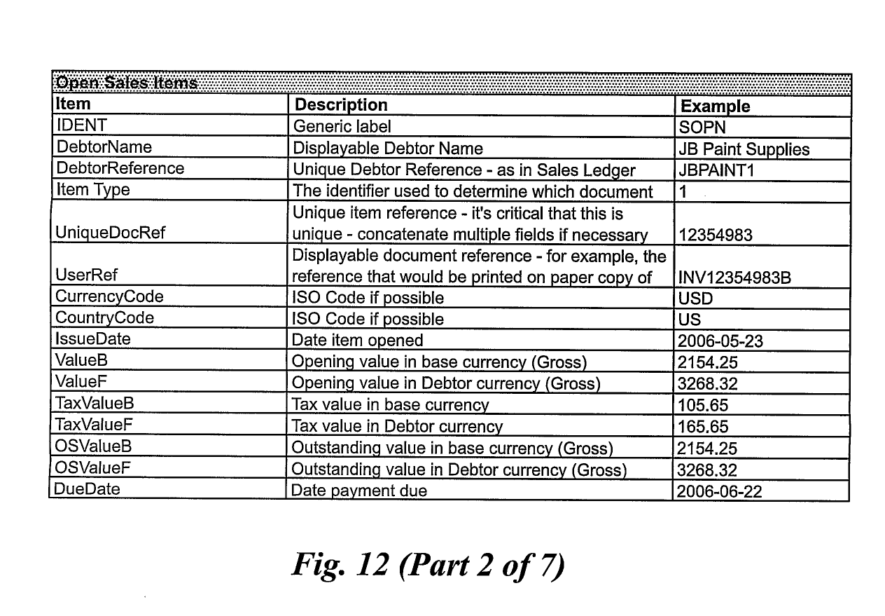

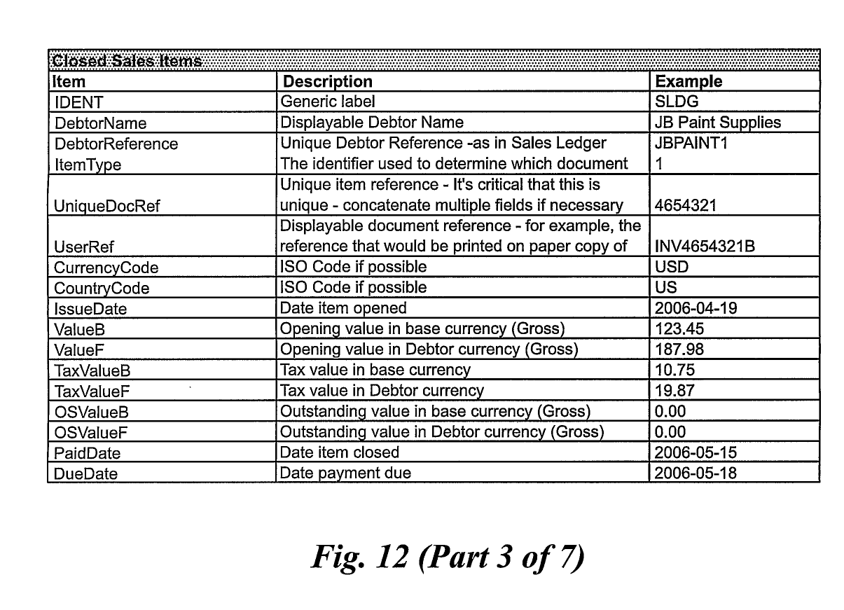

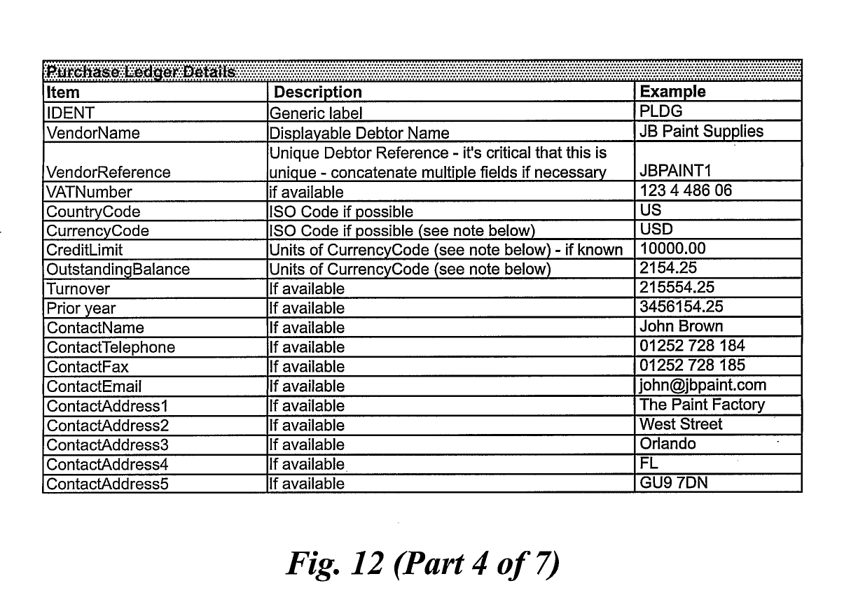

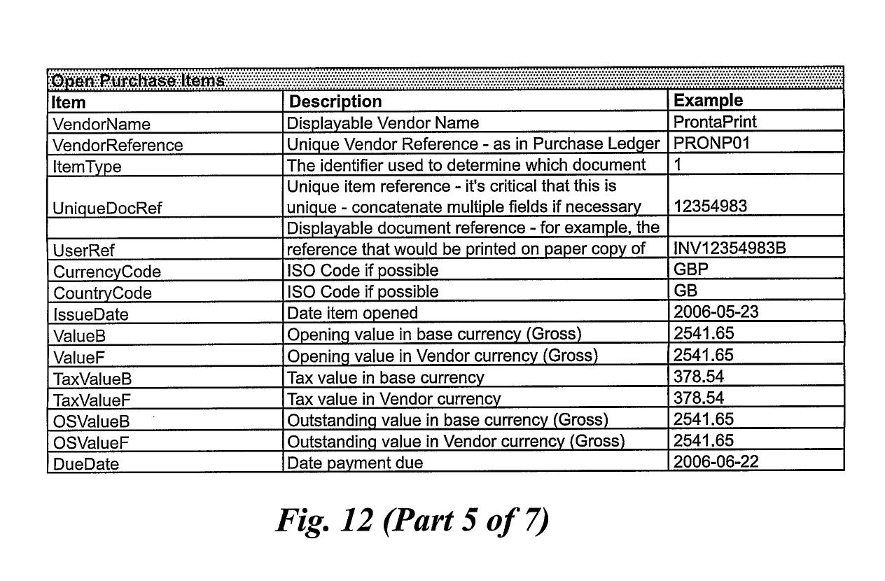

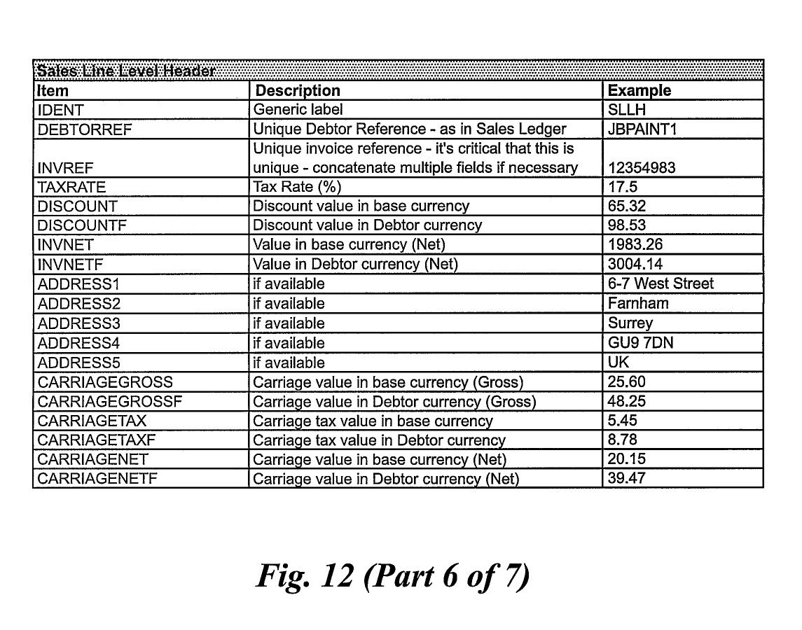

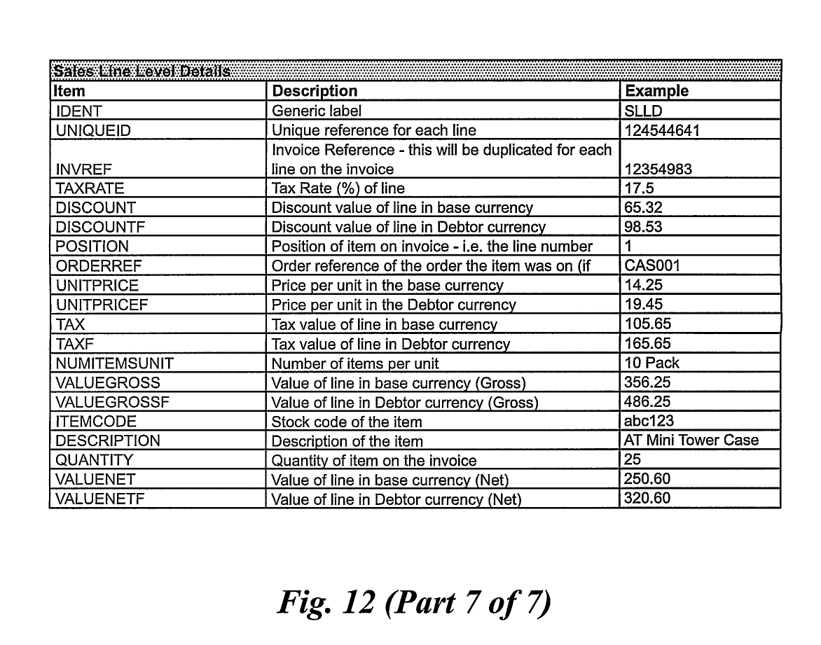

An example of the schema to which the “raw” unified data is stored is shown in FIG. 12.

The “raw” unified data can subsequently be transformed, using transformation software module 162, into any form with any associated file extension in accordance with the requirements of the End User (“resultant unified data”). This further transformation can be initiated by software on the server 40 calling the SQL Data base on the data processing server.

It is noted that the transformed file may either be called by or pushed to the End User on as frequent a basis as they can consume or require.

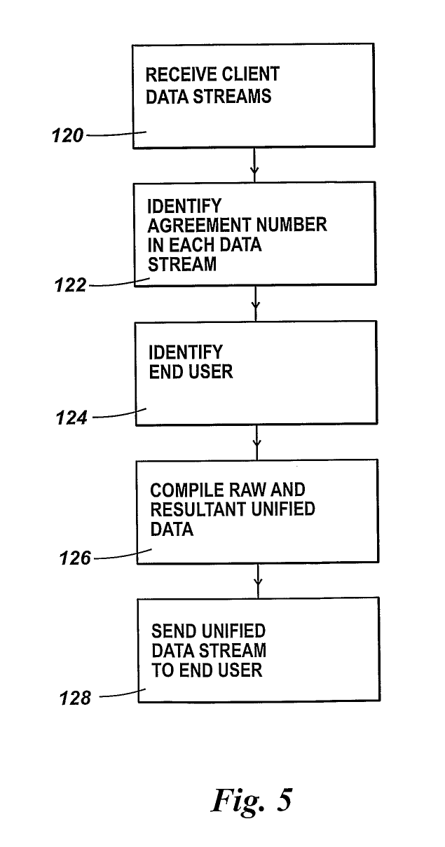

FIG. 5 is a flow chart showing the processes occurring on the data processing server 40 in accordance with the further embodiment of FIG. 4.

In Step 120, client streams are received via the Internet 16 (or other communications network). In Steps 122 and 124 the server 40 looks to identify the client from which the data has originated either by looking for a specific Agreement number or by looking at a dummy data record 54 and identifying the unique reference number contained therein.

In Step 126, the received data is transformed into the raw and resultant forms described above and in Step 128 the unified data stream is sent to the End User's server 42.

In an alternative embodiment to the arrangement depicted in FIG. 4, the extraction module 44 may perform the conversion of the un-unified data records into a unified format prior to transmission to the data processing server 40.

In this alternative embodiment therefore the conversion software module 160 on the data processing server 40 may either be deactivated or potentially may not even be present. Instead, the extraction module 44 will take the raw accounting data (un-unified data records) and unify the data on the client side 2. A unified data file (e.g. a “.tsv” file) may then be transferred (e.g. via HTTPS) to the data processing server 40.

It is noted that in this alternative embodiment, step 126 in FIG. 5 would be modified. Since the extraction module 44 has, in this embodiment, already performed the conversion of the extracted data on the client side computer, the data processing server 40 will only need to transform the received unified data into the resultant unified data format.

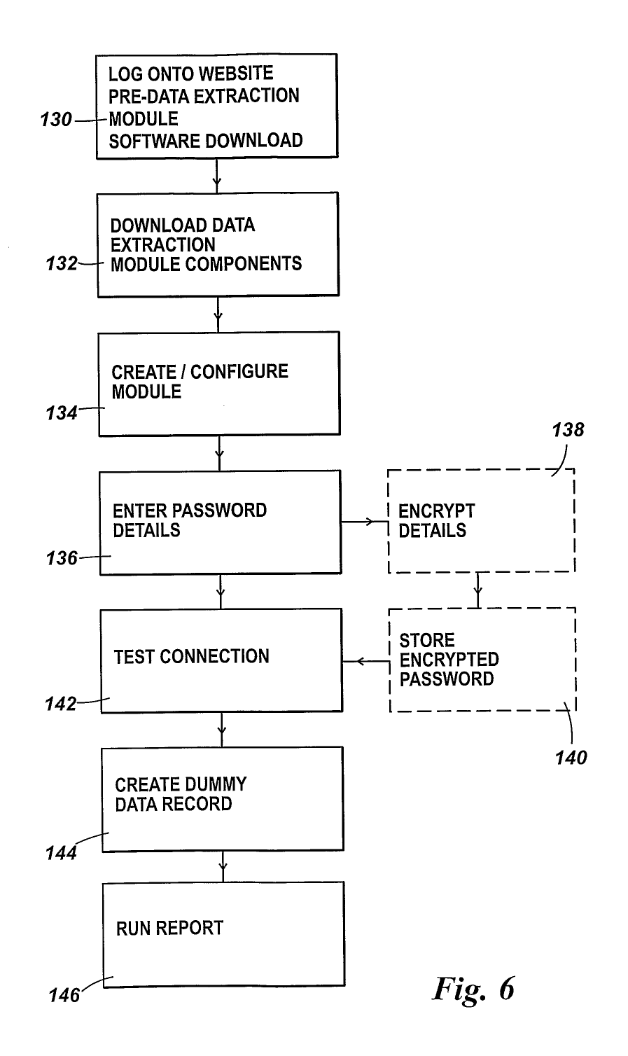

FIG. 6 shows the process of downloading and installing the data extraction module on a remote client computer.

In Step 130, a client user at the remote client computer logs onto a website offering the data extraction software components for download. Prior to downloading the profile and executable application components described above, the website (or a helpdesk operator/technician associated with the website) performs a check of the client user's computer to ensure they have the appropriate administrative permissions to install the software. At this point the client user may be prompted to download and install a program to help in the installation process (e.g. a remote control program to enable the operator/technician to control the client user's computer during the set up procedure).

In Step 132, an installer program is downloaded from the website. This is an executable program that, when run, loads the data extraction module computer program onto the client's computer. Following a successful install of the executable program, a profile file is downloaded which comprises an Agreement number which is associated with the End User and which essentially acts as the End User's address so that data extracted from the client's computer is sent to the correct location.

It is noted that the Agreement number is distinct from the Trace Debtor which is used to distinguish between different ledgers held on a particular client's computer system.

The Profile File may also hold End User instructions relating to the tailoring and subsequent pre-processing of the data, e.g. collecting details of invoices or purchases made in multiple currencies.

It is noted that it is a common requirement for ledgers to be segmented into multiple currency streams. Segmentation may be achieved by pre-fixing certain invoices with a code that allows them to be distinguished. An example of where segmentation may be used is for temporary and permanent staff for recruitment companies.

The tailoring instructions within the Profile File are commonly associated with the needs of a particular End User and the way that their servers or software operate. It is therefore noted that there may be a high degree of customisation between different End Users.

At Step 134, the data extraction module is configured to the client's particular computer system requirements (i.e. essentially, the data extraction module needs to be told where to look on the hard drive of the client computer in order to access the data records stored in the database of interest). In this step the client user first identifies and notes the location on their computer of the database of the management application that they wish the data extraction module to mine information from. A database driver appropriate to that management program is then set up and finally the data extraction module is pointed at the database location.

In Step 136, the data extraction module is configured such that it can access the database controlled by the management application. The user may therefore be asked in this step for the username/password that they use to access the management application. These details may then be first encrypted in Step 138 and then stored locally (in Step 140) on the client computer (see encrypted password 58 in data store 14 in FIG. 2). This “local storage” of the access details is advantageous as it avoids the need for publicising sensitive security information in any way. Instead, the data extraction module merely asks for the information and stores it locally for later use.

Following the above set up steps, the data extraction module, in Step 142, performs a test connection with the data processing server. This step is performed to highlight any Firewall or other connectivity issues that may exist between the client user's computer and the data processing server. In the event that the test connection fails the reasons can be investigated and addressed prior to continuing with the rest of the installation process.

In Step 144, a dummy data record is added to the database by the data extraction module. The details of this dummy record are provided by the data processing server and would typically comprise a unique reference number that can be later used to identify different portions of a ledger originating from a particular Target/client (e.g. to distinguish between the spare parts sales ledger and also the consultancy ledger in the above mentioned example). It is noted that the splitting process is not normally one which accounting packages can automatically perform and in prior systems this would have been a manual process undertaken by the target in preparing the raw data for the End User).

It may be the case that a particular client hosts or manages multiple data sets (e.g. it may have multiple business divisions that act independently of one another). In such cases, a different unique reference number can be assigned to each data set.

In Step 146, a report is run. Typically, this might involve extracting data records over a predefined time period (e.g. the last 12 months) and then sending them to the End User via the data processing server. The client can then verify that the data records have been successfully transmitted by logging onto the End User's website and checking that their records have been updated with the new information.

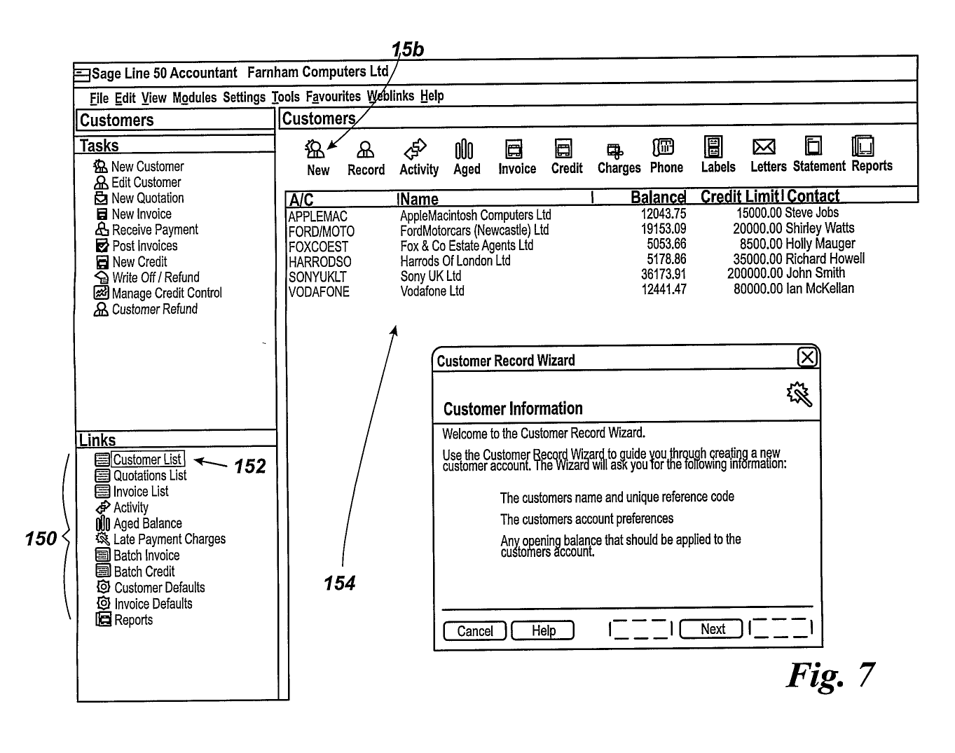

FIGS. 7 to 10 show a variety of screenshots on a client computer. The screen shots show the creation of the above mentioned dummy data record in accordance with an embodiment of the present invention.

In FIGS. 7 to 10 it is noted that the management application in question is an accounting package linked to a database comprising accounting related data records. The specific application depicted in these figures is “Sage line 50 Accountant”. It is however to be appreciated that the present invention may apply to any database management system and is not limited in any way by the type of information (e.g. financial, scientific, marketing etc.) contained within the data base.

In FIG. 7 a screenshot of a customer list is shown. A toolbar 150 towards the bottom-left of the screen provides links to different sections of the accounting package (e.g. customer list, invoice list, quotations list etc.). In FIG. 7 the “customer list” option 152 has been highlighted and the main window 154 shows a list of all the current customer accounts, e.g. Apple computers, Ford Motorcars etc.

If the client wishes to add a new customer to the list of customers then selecting the “new customer icon” 156 brings up a dialog box (a new customer' wizard) which prompts the user to enter the details of a new customer.

A dummy data record may therefore be entered by selecting the new customer icon and this process is described in greater detail below.

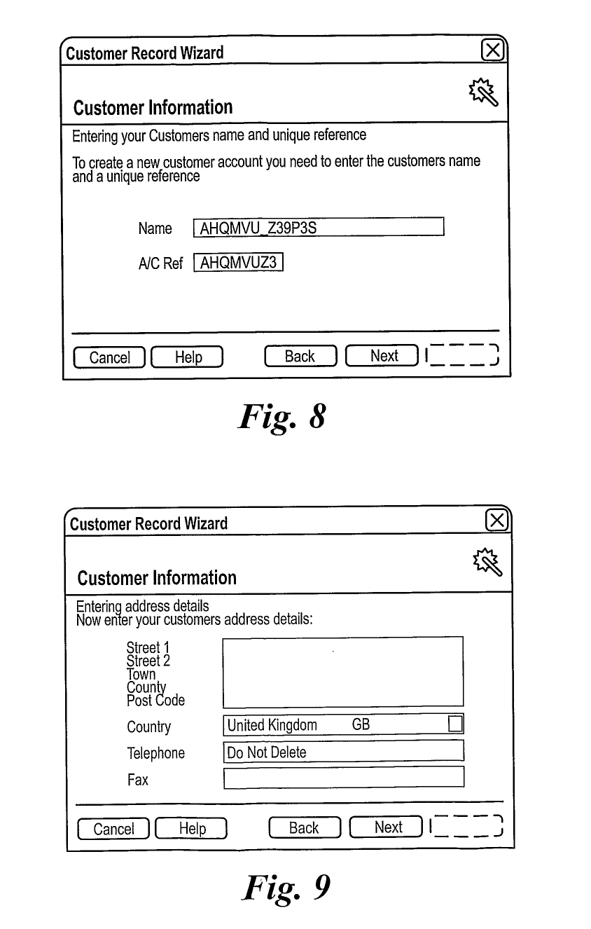

In FIG. 8, the user has now selected the “new customer” icon and has been prompted to enter the name and account reference of the new customer. Since this is not a real customer but the dummy data entry, the unique reference number provided during the set up process is added as the customer name (In this particular example there is a further field, the account reference field and this has filled in automatically).

In FIG. 9, further details for the “new” customer are now being requested. If this was an entry for a new customer the address, telephone, fax and other contact information would be entered at this point. However, since this entry is for a dummy data record these fields may be left blank or a reminder message (in this case “Do Not Delete—LTSBCF”) can be added to a suitable field, such as the telephone contact number, to remind the client from deleting the record.

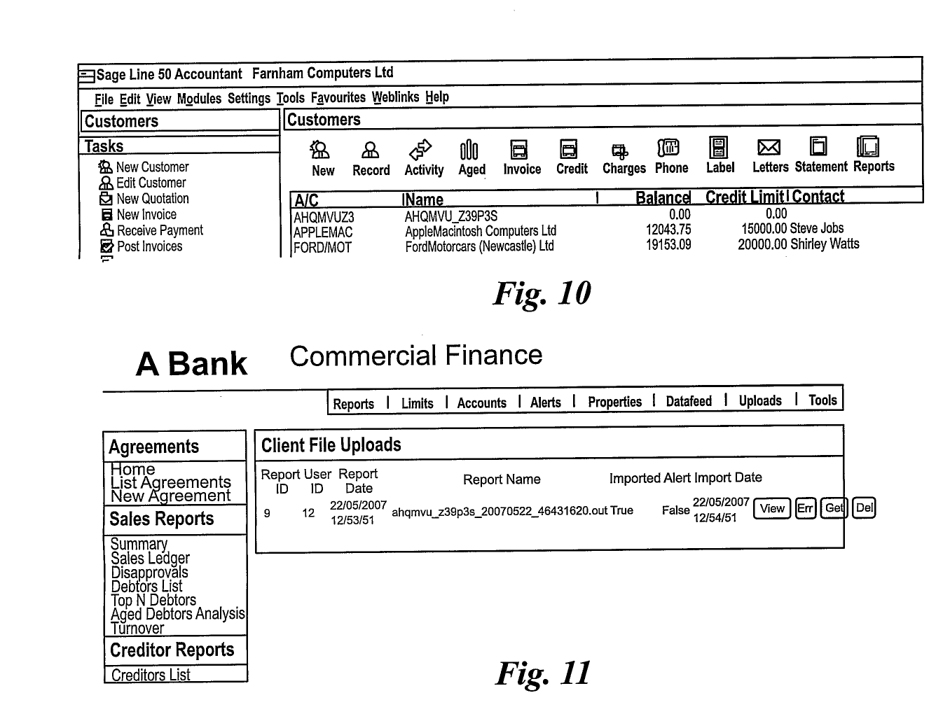

Following completion of the “new customer” wizard the dummy data record is added to the list of customers. FIG. 10 is a further screenshot, similar to that of FIG. 7, that now shows the updated customer list. The new customer is shown at the top of the list and this is the dummy data record 54.

As noted above the data extraction module 44 may be used to extract data records and export a report to an End User. In the example depicted in FIGS. 7 to 10, the End User is a bank and FIG. 11 shows the client area of the bank website that relates to the client of FIGS. 7 to 10. It can be seen that there is a report in the “Client file upload” section which is identified with the unique reference number entered in FIG. 8.

FIG. 12 shows an example of a schema (data specification) used to store data extracted from a database management system.

The schema shown in the Figure comprises:

“sales ledger details” which comprise details of all live debtors on the client side 2 computer system;
“open sales item” details which comprise details of all items that are open on the client side, e.g. unpaid invoices, unallocated credit notes, receipts, adjustments etc.;
“closed sales items” details which comprise details for items that are closed and have become closed within a certain time period—e.g. invoices that have been paid within the last 30 days, credit notes, receipts or other adjustments that have been allocated within the last 30 days (Note: the normal time period for closed items is 30 days in this example but may be varied as required. It is also likely that an initial “history” report containing all documents closed within the last 365 days would be needed in order to set up the server side 4 systems);
“purchase ledger details” which comprise details of all live vendors/suppliers currently on the client side system;
“open purchase items” which comprises details of all items (goods or services bought from suppliers) that are open e.g. unpaid invoices, unallocated credit notes, receipts, adjustments etc.;
“sales line level header” which comprises summary details of an sales invoice, discount, carriage and tax.
“sales line level detail” which comprises details of the individual lines of goods or services which are included in an invoice e.g. a 10 pack of AT mini Tower Cases, stock code abc123 at £14.50 p per unit and tax of 17.5% etc. An invoice might include multiple sales lines if the debtor has ordered more than one type of good or service.

It will be understood that the embodiments described above are given by way of example only and are not intended to limit the invention, the scope of which is defined in the appended claims. It will also be understood that the embodiments described may be used individually or in combination.

1. A data extraction module for extracting data stored in a database management system of a computer system, the database management system comprising a database and a management application for accessing the database, the data extraction module comprising:
inputs for receiving a request for data stored in the database;
extraction arrangement for accessing and extracting the requested data from the database, the extraction arrangement being arranged to use a database driver to access and extract data directly from the database;
outputs for outputting the extracted data wherein
the extraction arrangement is arranged to bypass the management application and access and run the database driver independently of the management application.

2. A module as claimed in claim 1, wherein the management application is associated with the database driver used to access the database.

3. A module as claimed in claim 1, wherein the database comprises a plurality of data records and the data extraction module is arranged to insert a dummy data record into the database, the dummy data record comprising a unique reference identifier.

4. A module as claimed in claim 1, wherein the database management system is password protected and the data encryption module is arranged to encrypt and store the password details of the database management system on the computer system.

5. A module as claimed in claim 4, wherein the encrypted password details are stored in a local storage area of the computer system

6. A module as claimed in claim 1, wherein the outputs are arranged to output the extracted data in the form of a data file

7. A module as claimed in claim 6, wherein the outputs are arranged to output the data file to a local storage area of the computer system.

8. A module as claimed in claim 6, wherein the outputs are arranged to output the data file as an encrypted data file.

9. A module as claimed in claim 7, wherein the data file is output to a mail application for emailing to a remote computer server

10. A module as claimed in claim 7, further comprising a file transfer protocol arranged to transmit the data file to a remote computer server

11. A module as claimed in claim 1, further comprising checking arrangement arranged to check the veracity of the extracted data prior to sending to the outputs.

12. A module as claimed in claim 1, wherein the data extraction module is embodied in the form of a computer application.

13. A module as claimed in claim 12, wherein the computer application comprises a profile component and an executable component, the profile component being arranged to insert a dummy record into the database and the executable component being arranged to access and extract requested data from the database.

14. A method of extracting data stored in a database management system of a computer system, the database management system comprising a database and a management application for accessing the database, the method comprising:
receiving a request for data stored in the database;
using a database driver associated with a data extraction module to access and extract the requested data directly from the database;
outputting the extracted data wherein
the data extraction module is arranged to bypass the management application and access and run the database driver independently of the management application.

15. A method of setting up a data extraction module in a computer system, the data extraction module being arranged to extract data stored in a database management system of the computer system, the database management system comprising a database and a management application for accessing the database, the method comprising the steps of:
installing a profile component on the computer system, the profile component being arranged to insert a data record into the database, the data record comprising a unique reference number
installing an executable component on the computer system, the executable component being arranged to provide the computer system with an extraction arrangement for accessing and extracting requested data from the database, the extraction arrangement being arranged to use a database driver to access and extract data directly from the database wherein the extraction arrangement is arranged to access and run the database driver independently of the management application.

16. A computer program comprising program instructions for causing a computer to perform the method of claim 14.

17. A computer program comprising program instructions for causing a computer to perform the method of claim 15.
